(19) United States
(12) Patent Application Publication
(10) Pub. No.: US 2009/0299620 A1
(43) Pub. Date: Dec. 3, 2009

(54) METHOD FOR SEARCHING ROUTES OF A PORTABLE TERMINAL

(75) Inventors: Dong Jun SHIN, Seoul (KR); Kyoung Taek Kim, Seongnam-si (KR); Hyun Kyoung Kim, Seoul (KR); Hyang Ah Kim, Seongnam-si (KR); Jin Yong Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/421,412

(22) Filed: Apr. 9, 2009

(30) Foreign Application Priority Data
May 28, 2008 (KR) 2008-0049569

(51) Int. Cl. G01C 21/00

(52) U.S. Cl. 701/200

(57) ABSTRACT

The present invention relates to a navigation function of a portable terminal. The invention provides a route search method of a portable terminal to provide various route search option in the navigation function, besides a conventional search option that guides a shortest route.

### CROSS REFERENCE TO RELATED APPLICATION

This application claims priority from and the benefit of Korean Patent Application No. 2008-0049569, filed on May 28, 2008, which is hereby incorporated by reference for all purposes as if fully set forth herein.

### BACKGROUND OF THE INVENTION

1. Field of the Invention

The present invention relates to a route search method of a portable terminal that provides a navigation function suitable for the request of user by providing various search options.

2. Discussion of the Background

A portable terminal includes various functions to meet the demands of a user thereof in the modern digital era. For example, the portable terminal may include various services including an electronic notebook function, a game function, and a schedule management function. Recently, demand has increased for the portable terminal that provides a navigation function.

The navigation function typically shows the current position of a moving body to a user in a visual map format after the portable terminal has received position data indicating the latitude, the longitude, and the altitude of the user. The position data may be transmitted from Global Positioning System (GPS) satellites, and the navigation function in the portable terminal computes the current position of the terminal based on the position data. The navigation function may provide various information to the user that includes the direction in which the user is moving, the distance to a destination, the current speed of the user, and the shortest route to a destination.

However, the conventional route search options described above may not satisfy various demands of the user. For example, if the user wants to go to a destination using a suitable road for driving, such a suitable driving route for the user may not be provided in the above-described search option. To solve this problem, the user may be required to search for the suitable road and set it as a passage route. Accordingly, in order for the navigation function to provide a route to a destination, various route search methods may be required in addition to a conventional route search option as described above.

### SUMMARY OF THE INVENTION

The present invention provides a route search method of a road guidance service or a navigation function of a portable terminal that is capable of searching various routes suitable for the demands a user.

Additional features of the invention will be set forth in the description which follows, and in part will be apparent from the description, or may be learned by practice of the invention.

The present invention discloses a method of searching a route in a navigation function that includes: displaying a shortest route between a departure location and a destination; receiving a search word that corresponds to an intermediate point; searching at least one intermediate point based on the received search word; and displaying at least one sub-route between the departure location and the destination, the at least one sub-route including the searched intermediate point.

The present invention also discloses a portable terminal providing a navigation function that includes: a controller to control in order to search and to display a shortest route between a departure location and a destination; an input unit to receive a search word that corresponds to an intermediate point; a information search unit to search the intermediate point according to the received search word; a route calculation unit to calculate at least one sub-route including the searched intermediate point; and a display unit to display the shortest route and the at least one sub-route.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a schematic configuration of a portable terminal according to an exemplary embodiment of the present invention.

FIG. 2 is a flowchart showing a route search process of a portable terminal according to an exemplary embodiment of the present invention.

FIG. 3A, FIG. 3B, FIG. 3C, FIG. 3D, FIG. 3E, FIG. 3F, FIG. 3G, and FIG. 3H are an diagrams of portable terminal screen displays according to exemplary embodiments of the present invention.

FIG. 4 is a flowchart showing a process of searching a sub-route according to an exemplary embodiment of the present invention when a search word is “pick-up”.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

Hereinafter, a portable terminal according to an exemplary embodiment of the present invention is shown as a mobile communications terminal. However, the present invention is not restricted thereto. That is, the portable terminal according to an exemplary embodiment of the present invention is a terminal that includes a road guidance service, that is, the navigation function. The present invention can be applied to all information and telecommunication devices and multimedia devices, such as a mobile communications terminal, a mobile phone, a Personal Digital Assistant (PDA), a smart phone, an International Mobile Telecommunication 2000 (IMT-2000) terminal, a Code Division Multiple Access (CDMA) terminal, a Global System for Mobile communication (GSM) terminal, a Universal Mobile Telecommunication Service (UMTS) terminal, a digital broadcasting terminal, and to applications thereof.

The “search word” used herein is a term that a user inputs so as to select a sub-route. The search word can be preset and stored in storage. That is, the portable terminal can select a pass-through corresponding to the search word in the selection of the sub-route to search the sub-route.

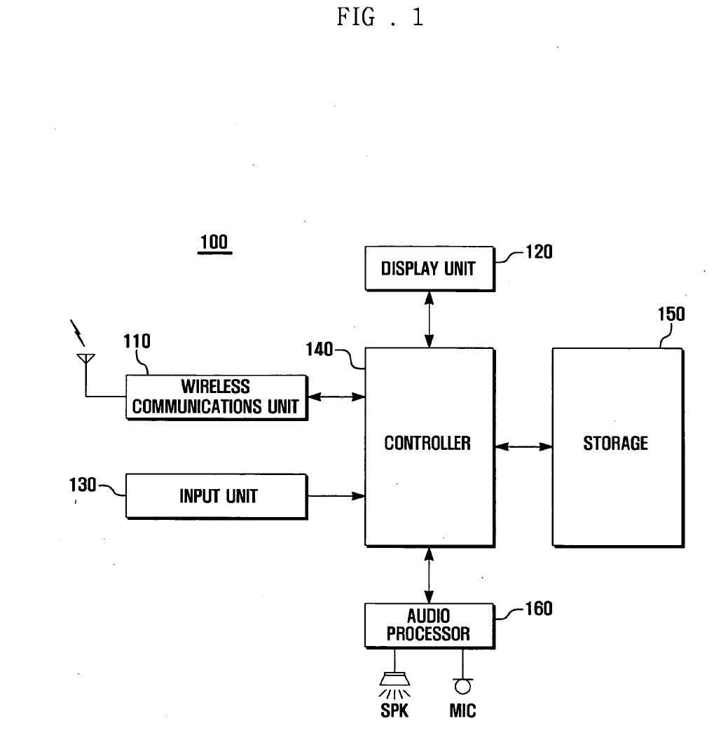

FIG. 1 is a block diagram that schematically shows a configuration of a portable terminal 100 according to an exemplary embodiment of the present invention.

Referring to FIG. 1, the portable terminal 100 according to an exemplary embodiment of the present invention includes a wireless communications unit 110, a display unit 120, an input unit 130, a controller 140, a storage 150, and an audio processor 160.

The wireless communications unit 110 can perform a Radio Frequency (RF) telecommunication function of the portable terminal 100. Such a wireless communications unit 110 includes a transceiver separator that separates a RF signal into a transmission signal and a receive signal, a RF transmitter that upconverts and amplifies the frequency of the transmitted RF signal, and a RF receiver that low noise-amplifies the received RF signal and downconverts the frequency. The wireless communications unit 110 may includes a GPS receiver to provide a road guidance service. The GPS receiver can receive a signal that includes position data transmitted by a plurality of GPS satellites.

Moreover, the GPS receiver can include a sensor unit including a velocity sensor and a gyro sensor, and the rotation angle and speed of the portable terminal 100 can be sensed by using the sensor unit. The wireless communications unit 110 can download a map data for the road guidance or download an update data for renewing a stored map data under the control of the controller 140.

Moreover, the wireless communications unit 110 can form a communications channel with a web server or another person's terminal and transmit another person's location information request message under the control of the controller 140, and can receive another person's location information from the web server or the other person's terminal. The wireless communications unit 110 transmits the other person's location information request message in a preset cycle and can receive the other person's location information under the control of the controller 140.

The wireless communications unit 110 transmits the other person's location information request message together with period information under the control of the controller 140, so that the web server or the other person's terminal can transmit the other person's location information in a given period. When arriving at the location of the other person, the wireless communications unit 110 can transmit a stop message that stops the transmission of other person's location information to the other person's terminal or the web server under the control of the controller 140. The display unit 120 can display various screens according to the use of the portable terminal 100, for example, a stand-by screen, a menu screen, and a call screen. The display unit 120 may be a Liquid Crystal Display (LCD), and in this case, the display unit 120 can include an LCD controller, memory that can store data, and an LCD display device.

When the LCD is implemented using a touch screen mode, the display unit 120 can also operate as an input unit 130, which will be described below. Particularly, the display unit 120 according to an exemplary embodiment of the present invention can display a moving speed, road information, a traffic condition, a sub-route selected by the search word, which will be described below, and a shortest route. The display unit 120 can display the necessary time and the distance in the use of the shortest route and the sub-route, and the display unit 120 can display one path that the user selected from a plurality of available existing paths.

The input unit 130 can include a plurality of input keys for inputting numbers or character information and a function key for setting up the various functions. The function key can include directional keys, side keys, and short cut keys, which are set for performing specific functions. Also, the input unit 130 can transmit a key signal inputted in connection with a user setting and a functional control of the portable terminal 100, to the controller 140. Particularly, the input unit 130 according to the present exemplary embodiment can receive information of a departure, an intermediate point, and a destination inputted by a user, and deliver a corresponding signal to the controller 140. Also, the input unit 130 can deliver a search word for selecting a sub-route to the controller 140.

The controller 140 can control the overall operation of the portable terminal 100 and signal flow between the internal blocks of the portable terminal 100 and perform data processing function. Moreover, the controller 140 can select a departure location based on location information obtained through a GPS receiver and can control in order to search the shortest route to the destination and display it on the display unit 120.

According to the present exemplary embodiment, the controller 140 can calculate a sub-route according to a search word inputted by a user. In detail, the controller 140 can calculate the shortest route to the destination inputted by a user and display it on a map. Thereafter, when a user activates an extended searching menu in order to calculate a sub-route, the controller 140 can control the display unit 120 to display an input window for a search word. When a user inputs a search word, the controller 140 can select an intermediate point based on the search word, calculate a sub-route passing through the intermediate point and display the sub-route. The sub-route may be displayed with at least one of another color or symbol in order to distinguish the sub-route from the previously displayed shortest route.

Also, when using a sub-route, the controller 140 can control in order to calculate the necessary time and the distance and display it on the display unit 120; and to display the surrounding traffic conditions of the sub-route received through the wireless communications unit 110. The controller 140 can include an information search unit for searching an intermediate point by analyzing the search word inputted by a user, and a route calculation unit for calculating a sub-route according to the searched intermediate point.

The information search unit can detect an intermediate point by analyzing the search word inputted by a user. In detail, the information search unit can search geographical features on a map corresponding to the search word and determine the geographical features as an intermediate point. For example, when a user inputs “rain” as a search word, the information search unit can determine an underground passage, from which the user may escape the rain, and set it as the intermediate point. Also, when a user inputs “department store” as a search word, the information search unit can search a department store near the shortest route and deliver it to the route calculation unit.

Moreover, if “discount” or “sale” is inputted together with “department store” as the search word, a department store has a discount or sale event among the department stores near the shortest route is searched first. A user can set up search options so that the information search unit searches only the intermediate points that are located within a given distance, for example, within a 1 Km radius from the searched shortest route. The route calculation unit, by receiving the intermediate point selected by the information search unit according to the search word inputted by a user, can calculate a sub-route that passes through the intermediate point.

The route calculation unit can calculate the necessary time or the distance according to the use of the sub-route. Moreover, when there are several searched intermediate points, the route calculation unit can calculate the sub-route according to each intermediate point and transmit to the display unit (120) the necessary time, distance, and traffic congestion degree according to each sub-route, so that a user can select one of the several sub-routes. The controller 140 can use at least one among different symbols or different colors in order to distinguish the several sub-routes. The controller 140 can differentiate the route searching according to a transportation mode (walking, a bicycle, and a vehicle). For example, when walking is selected as the transportation mode through an input unit 130, the controller 140 can automatically search and provide the sub-route whose intermediate points are a walkway, a park, or the like.

If a user selects walking as the transportation mode, the controller 140 can input a park or a walkway as the search word, and search an intermediate point. In addition, when the transportation mode is a bicycle, the controller 140 can automatically search a sub-route that uses a bicycle path. For this, if a user selects a bicycle as the transportation mode, the controller 140 can input a bicycle path as the search word and search an intermediate point.

The storage 150 can store a user data as well as a program needed for the navigation function operation according to the present exemplary embodiment. Particularly, the storage 150 according to the present exemplary embodiment can store a map data for road guidance. The map data includes not only basic road information but also additional information about a shopping mall, a theater, a walkway, a park, a bicycle path, and the like. These map data and additional information can be updated by receiving update files from a web server. Such storage 150 can include a program area and a data area. The program area can store a program controlling the overall operation of the portable terminal 100; an Operating System booting the portable terminal 100; an application program needed for multimedia content playback; and an application program needed for other option functions of the portable terminal 100, for example, a camera function, a sound playback function, or an image or video playback function. The program area according to the present exemplary embodiment can store a program that can select the intermediate point corresponding to the search word inputted by a user to calculate the sub-routes, and calculate the location of the portable terminal 100. The data area is an area in which data generated according to the use of the portable terminal 100 is stored, and can store a phone book, audio data, and information corresponding to specific contents or the user data. Particularly, the data area according to the present exemplary embodiment can store map information or road information and traffic condition transmitted from the GPS receiver. These data can be displayed on the display unit 120 under the control of the controller 140.

The audio processor 160 can play the received audio signal or can transmit the audio signal such as a voice inputted from a microphone (MIC) through a wireless communications unit 110 under the control of the controller 140. Particularly, the audio processor 160 of the present invention can inform a user of exceeding a speed limit, a lane guidance, or traveling outside of the route, by generating a voice signal when guiding a route to the destination under the control of a controller 140. Also, although not shown, the portable terminal 100 can further include elements having an additional function such a camera module, a broadcasting reception module, a connection port for exchanging data with an external device, a charging port, and a digital sound source playback module like an MP3 module.

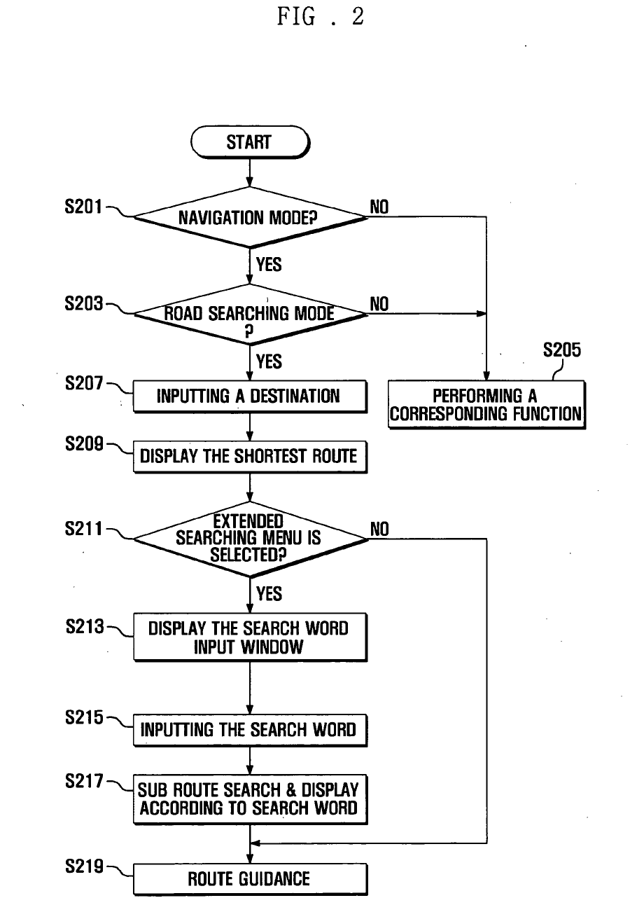

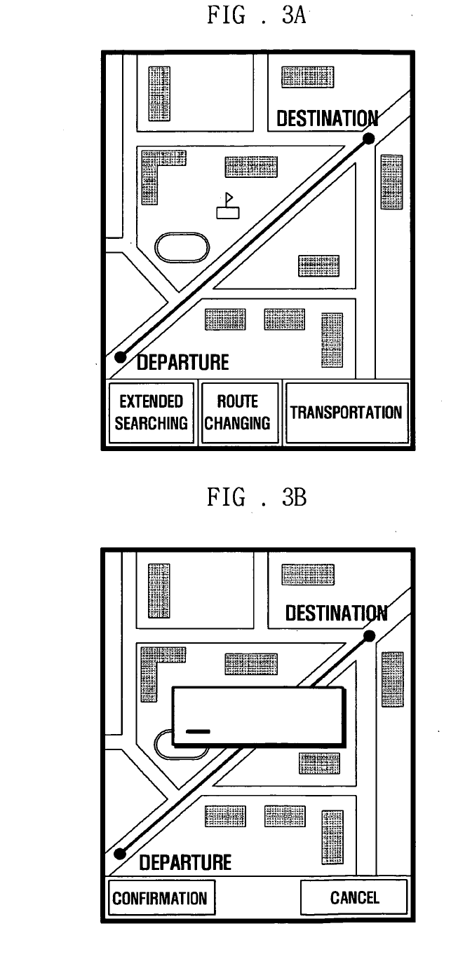

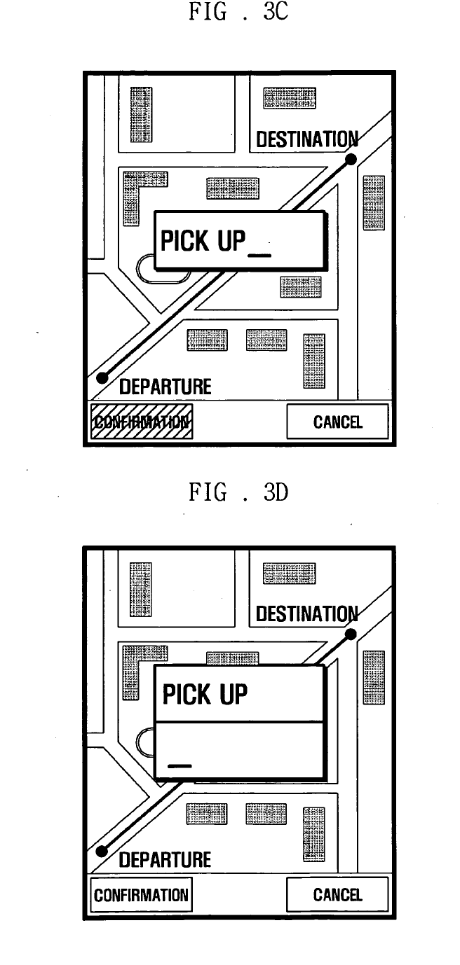

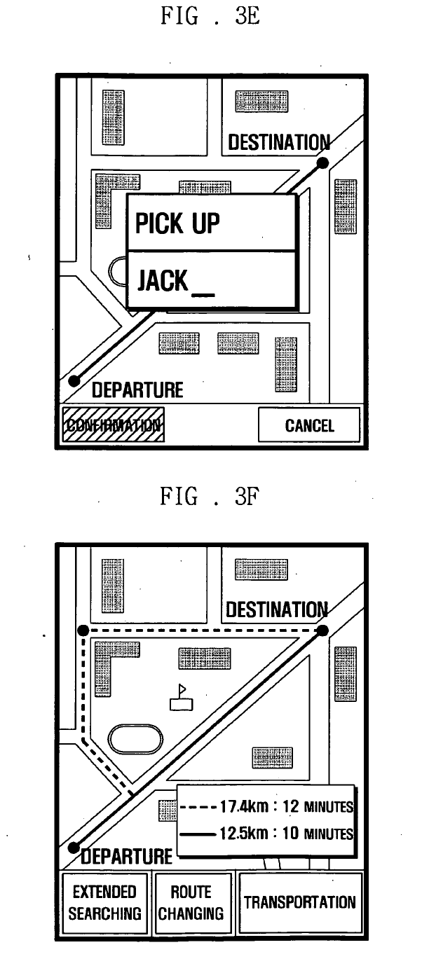

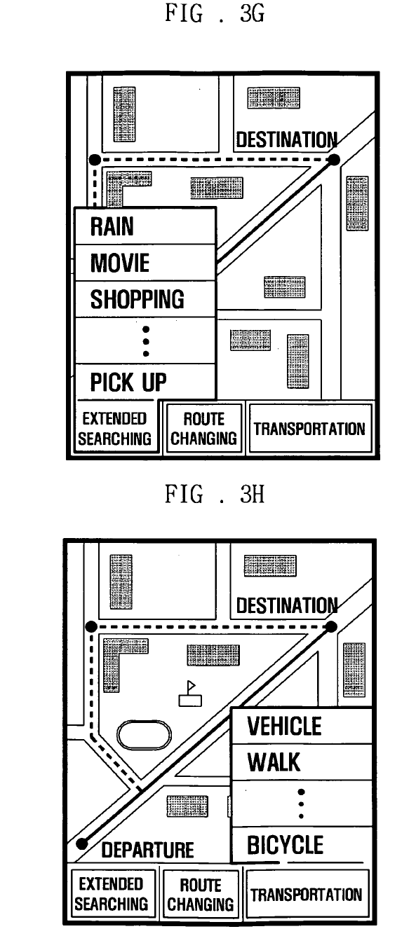

FIG. 2 is a flowchart showing the process of providing sub-routes according to an exemplary embodiment of the present invention. FIG. 3A, FIG. 3B, FIG. 3C, FIG. 3D, FIG. 3E, FIG. 3F, FIG. 3G, and FIG. 3H are diagrams of portable terminal screen displays according to exemplary embodiments of the present invention.

Referring to FIG. 1, FIG. 2, FIG. 3A, and FIG. 3B, the controller 140 can confirm whether a portable terminal 100 is a navigation mode (S201). If it is not a navigation mode at step S201, the controller 140 proceeds to step S205 to perform a corresponding function, for example, a stand-by state or a music playback function. When the portable terminal 100 is a terminal that provides only a navigation function, step S201 can be omitted. When it is determined that the terminal is in a navigation mode at step S201, the controller 140 can check whether the key for activating a road searching mode is inputted (S203).

If the road searching mode is not active at step S203, the controller 140 performs a corresponding function (S205). If the road searching mode is active at step S203, the controller 140 activates a destination input window so that a user can input a destination (S207). The controller 140 can check the current location and set it as a departure location. For this, a controller 140 can receive data including location information from the GPS receiver and check the current location. In addition, the controller 140 can display a departure location input window and a destination input window respectively, or can receive a destination after a departure location is inputted through one input window. The controller 140 that received a destination at step S207 can control the display unit 120 to display a shortest route from the current location to the destination as shown in the exemplary screen display view in FIG. 3A (S209).

The controller 140 can control one part of the display unit 120, as shown in FIG. 3A, so that the display unit 120 displays an extended searching menu for selecting a sub-route, a route changing menu for changing the selected route among a plurality of the routes, and a transportation menu for selecting a transportation mode, such as a vehicle, walking, or a bicycle, at the lower part of the display unit 120. Thereafter, the controller 140 can check whether the extended searching menu is selected (S211). If the extended searching menu is not selected at step S211, the controller 140 can start a route guidance (S219).

If the extended searching menu is selected at step S211, the controller 140 can control so as to display a search word input window on the display unit 120 as shown in FIG. 3B (S213). If the search word input window is displayed, a user can input a search word for searching a sub-route into the search word input window through the input unit 130 (S215).

The controller 140 that receives the search word from the input unit 130 can search an intermediate point according to the inputted search word, and display the sub-route passing through the searched intermediate point, on the display unit 120. When there are several searched sub-routes, the controller 140 can determine a priority according to the conditions like a distance to the shortest route and time, and can display as many sub-routes on the display unit 120, as set by the user, according to priority. Thereafter, if a user selects one route among the several routes (including a shortest route or one or more sub-routes) displayed on the display 120, the controller 140 can start a route guidance (S219). The controller 140 can terminate the route guidance on arrival to the destination.

When an event like an accident occurs on the current travel route during the route guidance, the controller 140 can inform the user and then search a detour route.

Although according to the above described exemplary embodiments, a user may search sub-routes subsequent to a search, and display the shortest route, the present invention is not limited thereto. That is, the present invention may be used to search another sub-route when a user has already selected a route by using one of the searching methods described above. Hereinafter, a process of providing sub-routes according to an exemplary embodiment of the present invention is explained using an example of a case that a user inputs “pick-up” as a search word.

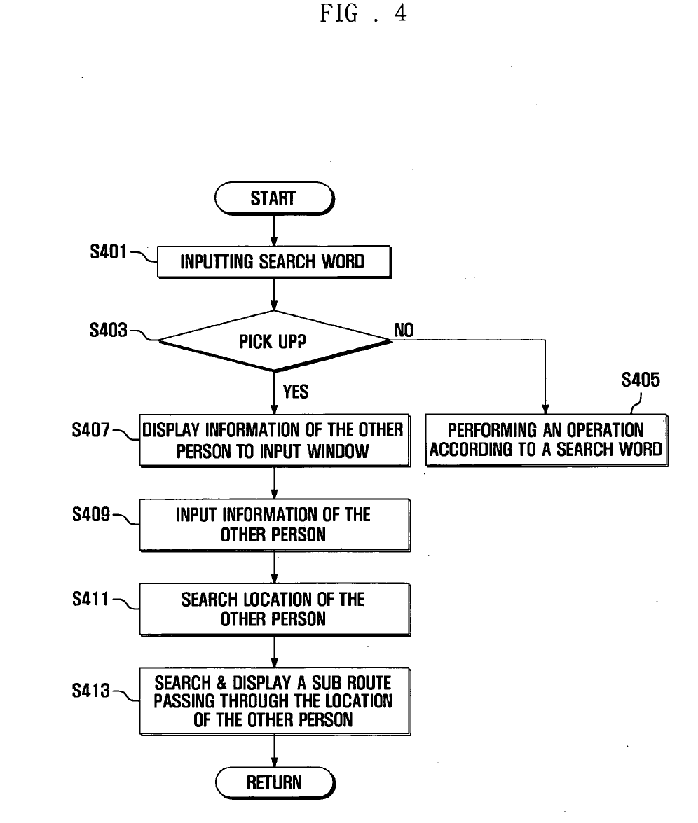

FIG. 4 is a flowchart showing a process of searching a sub-route when a search word according to an exemplary embodiment of the present invention is “pick-up”.

Referring to FIG. 1, FIG. 3C, and FIG. 4, a user can input a search word by using the input unit 130 (S401). Accordingly, the controller 140 can check whether the search word is “pick-up” (S403). If the search word checked at step S403 is not “pick-up,” the controller 140 can search the sub-route by selecting an intermediate point corresponding to the search word (S405). For example, if the search word is “rain,” the controller 140 can search an underground passage in which a user may escape from rain. If the search word is “movie,” the controller 140 can set a movie theater (for example, a movie theater located within a distance or a travel time set by a user) near the shortest route as an intermediate point and search the sub-route.

If a service in connection with a web server is provided, such as requesting information about movies, movie theater location information and showing lists and reservation service information of each movie theater may be provided. The movie theater location information and the showing lists and reservation service information can be displayed together while the sub-route is being displayed. Moreover, by inputting a title of a movie, a movie theater showing that movie can be searched and displayed. If the search word is “shopping” or “department store,” for example, the controller 140 can request the web server for a place related to the search word, like a shopping mall or department store near to the shortest route, receive the location information and the sale or discount event information of the department store or shopping mall from the web server, and display it along with the sub-route on the display unit 120.

When the search word is “pick-up” at step S403, as shown in FIG. 3C, the controller 140 can display an input window in which the information of the other person to be picked up is inputted on the display unit 120 as shown in the FIG. 3D (S407). Then, a user can input the information of the other person into the input window as shown in FIG. 3E (S409). The information of the other person can be a name or a telephone number. However, the present invention is not limited to the ways to identify the person to pick up to that described above. For example, the controller 140 can display information of a phone book when inputting the menu key linked to the phone book, so that a user can select the other person to be picked up among the information of the displayed phone book. In addition, the controller 140 can display the current call history and select the other person to be picked up.

If inputting the information of the other person is completed at step S409, the controller can search the location of the inputted other person (S411). The explanation on the method of searching the location of the other person is omitted as it is well known in the art. For example, the controller 140 can request for the location search by transmitting a location searching request message through a wireless communications unit 110 to the web server, which provides a location searching service, or to the other person's terminal, and can receive the location information of the other person to be picked up from the web server or the other person's terminal.

If the other person is not registered for the location check service, the controller 140 can transmit the message asking the consent of location check to the other person's terminal. On the other person's consenting who received the message asking the consent of location check, the controller 140 can check the location information of the other person. If the location searching for the other person is completed at step S411, the controller 140 can search the sub-route having the other person's location as an intermediate point and display it on the display unit 120 as shown in FIG. 3F. Then, the controller 140 can display the necessary time or the distance respectively in the use of the shortest route or the sub-route on the display unit 120. The specific explanation on the next process (S413) is omitted as it is identical with the one explained in FIG. 2.

The controller 140 can periodically check the location of the other person. If the other person moves from the previous location when the controller 140 is checking the location of the person, the controller 140 can inform this to the user by a voice signal through the audio processor 160 or by displaying a pop-up window on the display unit 120, and re-search a new route having the changed location as an intermediate point. The present invention is not limited to the process of using the inputted search words to search a route according to the exemplary embodiment described above. For example, as shown in FIG. 3G, the stored search word lists can be displayed in a form of a pop-up window so that a user can select a specific search word.

Moreover, the portable terminal 100 according to the present invention can include a menu for selecting a transportation mode as shown in FIG. 3H. That is, the route searching process according to the present invention can first search a walkway or a park when the transportation mode is walking; and first search a bicycle path in case the transportation mode is a bicycle. Here, the exemplary view shown in FIG. 3H does not limit the present invention. For example, the transportation mode selection menu can be made so as to be included in the extended searching menu. Searching a sub-route was explained above to use a map data stored in the portable terminal but the present invention is not limited to this. That is, the present invention can be configured in a way of linking a web server to the portable terminal 100. For example, when there are several searched routes, a user can access the web server and select a sub-route by checking recommended numbers or checking replies about the intermediate point.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of searching a route in a navigation function, the method comprising;
displaying a shortest route between a departure location and a destination;
receiving a search word that corresponds to an intermediate point;
searching at least one intermediate point based on the received search word; and
displaying at least one sub-route between the departure location and the destination, the at least one sub-route comprising the searched intermediate point.

2. The method of claim 1, wherein searching at least one intermediate point comprises:
searching geographical features on a map that correspond to the received search word;
detecting the geographical features located within a distance set based on the shortest route among the searched geographical features; and
determining the searched geographical features as an intermediate point.

3. The method of claim 2, wherein, when the search word is “rain,” the geographical features comprise an underground passage.

4. The method of claim 1, wherein, when the search word is “pick-up,” searching at least one intermediate point comprises:
activating an input window of pick-up information;
inputting the pick-up information;
searching a pick-up location; and
determining the pick-up location as the intermediate point.

5. The method of claim 4, wherein searching the pick-up location comprises;
transmitting a location information request message to a terminal or a web server, the terminal or web server to check the pick-up location information; and
receiving the pick-up location information from the terminal or the web server.

6. The method of claim 4, wherein searching the pick-up location is performed in a preset period, and a route re-searching is performed according to a change of intermediate point based on a movement of the pick-up location.

7. The method of claim 1, further comprising displaying a necessary time and a distance in the use of the shortest route and the at least one sub-route.

8. The method of claim 1, further comprising selecting a transportation mode comprising a vehicle, walking, and a bicycle.

9. The method of claim 8, when the transportation mode is walking, wherein receiving a search word comprises receiving “park” or “walkway” as the search word, and wherein searching at least one intermediate point comprises searching a sub-route in which a park or a walkway adjacent to the shortest route is set as an intermediate point.

10. The method of claim 8, when the transportation mode is bicycle, wherein receiving the search word comprises receiving “bicycle path” as the search word, and
wherein searching at least one intermediate point comprises searching a sub-route in which a bicycle path adjacent to the shortest route is set as an intermediate point.

11. The method of claim 1, when the search word is “movie,” wherein searching at least one intermediate point comprises:
accessing a web server;
requesting movie information from the web server, the web server to provide a movie theater location between the departure location and the destination; and
receiving movie theater location information and additional movie information from the web server,
wherein displaying the at least one sub-route comprises displaying the movie theater location information and the additional movie information.

12. The method of claim 1, when the search word is “shopping” or “department store,” wherein searching at least one intermediate point comprises:
accessing a web server;
requesting shopping mall information or department store information from the web server, the web server to provide a shopping mall location or a department store location between the departure location and the destination to the web server; and
receiving the shopping mall location or the department store location information, and additional shopping mall information or additional department store information from the web server,
wherein displaying the at least one sub-route comprises displaying the shopping mall location information or the department store location information, and displaying the additional shopping mall information or the additional department store information.

13. A portable terminal providing a navigation function, the portable terminal comprising;
a controller to control in order to search and to display a shortest route between a departure location and a destination;
an input unit to receive a search word that corresponds to an intermediate point;
a information search unit to search the intermediate point according to the received search word;
a route calculation unit to calculate at least one sub-route comprising the searched intermediate point; and
a display unit to display the shortest route and the at least one sub-route.

14. The portable terminal of claim 13, wherein, when the search word is “rain,” the information search unit searches an underground passage that is positioned within a given distance of the shortest route.

15. The portable terminal of claim 13, further comprising a wireless communications unit to form a communication channel with a web server or another terminal, the communication channel being under the control of the controller, wherein, when the search word is “pick-up,” the controller transmits a pick-up location information request message to the web server or the other terminal according to an input signal received from the input unit, and the controller to control the wireless communications unit so as to receive the pick-up location information from the web server or the other terminal.

16. The portable terminal of claim 15, wherein the information search unit searches a sub-route by determining the pick-up location information received from the wireless communications unit as an intermediate point.

17. The portable terminal of claim 16, wherein the controller confirms a current position of the pick-up location by receiving the pick-up location information from the web server or the other terminal in a preset period, and searches a new sub-route based on a changed location.

18. The portable terminal of claim 13, wherein the display unit displays a necessary time and a distance in the use of the shortest route and the at least one sub-route.

19. The portable terminal of claim 13, wherein the controller confirms selection of a transportation mode through the input unit, and when the transportation mode is “walking,” searches a sub-route in which a park or walkway adjacent to the shortest route is set as the intermediate point.

20. The portable terminal of claim 19, wherein, when the transportation mode is a “bicycle,” the controller searches a sub-route in which a bicycle path adjacent to the shortest route is set as the intermediate point.
